(19) United States
(12) Patent Application Publication
(10) Pub. No.: US 2026/0251817 A1
(43) Pub. Date: Aug. 27, 2026

(54) METHOD AND SYSTEM FOR IMPROVED SNOW WATER EQUIVALENT ESTIMATES

(71) Applicant: Applied Research Team, Inc., Denver, CO (US)

(72) Inventor: Baxter Vieux, Denver, CO (US)

(21) Appl. No.: 19/077,546

(22) PCT Filed: Jul. 24, 2024
(86) PCT No.: PCT/US2024/039330

§ 371 Date: Mar. 12, 2025

Related U.S. Application Data
(60) Provisional application No. 63/551,955, filed on Feb. 9, 2024.

(51) Int. Cl. G01W 1/14

(52) U.S. Cl. CPC G01W 1/14

(57) ABSTRACT

A method for estimating snow water equivalent (SWE), including receiving radar samples of precipitation over a region of interest (ROI), and using microphysics parameters to calculate a weather radar SWE (WRSWE). Using a reference SWE for a location in the ROI, determine a loss function, and perform a minimization process on the loss function to optimize the parameters and optimize a Q value (Q₀). Finally, recalculating an optimized WRSWE using the optimized parameters, and multiplying the optimized WRSWE by Q₀ to determine a corrected SWE (CSWE) for the location. CSWE may be mapped throughout the ROI by use of actual and extrapolated Q₀ values. A system for estimating SWE, including radar samples of precipitation over a ROI, microphysics parameters, an RSWE for a location in the ROI, a graphical user interface, computer memory and a computer processor, wherein the processor is configured to execute instructions to perform the SWE estimation.

### CROSS-REFERENCE TO RELATED APPLICATIONS

This application claims priority to U.S. Provisional Patent Application No. 63/551,955, filed Feb. 9, 2024, and PCT Application No. PCT/US2024/039330, filed Jul. 24, 2024, which are hereby incorporated by reference herein in their entirety.

### BACKGROUND OF THE INVENTION

### Field of the Invention

Embodiments of the present invention relate generally to methods and systems providing for more accurate estimations of snow water equivalent from precipitation measurements.

### Relevant Background

### Environmental Significance

A key aspect of monitoring fresh water supplies for human consumption and environmental health is predicting the amount of water stored in snowpacks, which is represented by a metric known as snow water equivalent (SWE). In the western United States, about forty million people depend on mountain snowmelt for their primary water supply. Estimates of the snow water equivalent of snowpacks are used to forecast available water supplies and to make management decisions regarding the use of those water supplies. For example, reservoirs are used to store snowmelt for later use in agricultural irrigation and for municipal water supplies. Water managers must accurately determine the quantity and rates of water release from these reservoirs based on the SWE deposited by precipitation in the watershed above the reservoir. Failure to accurately estimate the amount of water stored in snowpack can accordingly lead to poor water resource management, and ultimately to water shortages.

In addition to aiding water management for human use, accurate estimates of SWE in snowpacks also improve management for broader environmental concerns. In times of surplus, reservoir stores of water can be used to recharge groundwater levels, providing resilience for future dry periods and supporting surface ecosystems. Downstream river flows are greatly influenced by the amount and rate of water released from reservoirs, meaning that water management decisions affect wildlife in river-adjacent areas, as well as the instream ecology of the river. Improved SWE estimates thus have the potential to greatly improve water management and the environment as well.

### TECHNICAL BACKGROUND

Snowpack coverage information may be collected by several means, including instruments located at ground stations or other ground-based instruments deployed remotely, such as Light Detection and Ranging (LiDAR) sensors or Radio Detection and Ranging (radar). Alternatively, radar and LiDAR sensors may be deployed on airborne or space-based platforms. Though less accurate, satellite platforms may also employ visible and thermal wavelength sensors or use passive or active microwave sensors. Whether ground, air, or space-based, remote sensors collect snowpack information and transmit such information to appropriate facilities for tabulation and archiving. Additional remote sensing technologies available for snowpack measurement are discussed in Doesken (2003), incorporated by reference herein.

Snowpack information is often derived from precipitation estimates, which may be collected through use of various types of radar sensors. Microwave radar signals may be projected in an area and the return signals analyzed to estimate the amount of water particles, i.e., hydrometeors, present at the time and place examined by the sensor. Hydrometeors may be in the form of ice, snow, water, or other particulate phases. Radar images aggregated over the examined area are then used to create a map of the hydrometeors for a given time. Radar data also provides information about the amount, distribution, size, and form of the hydrometeors. Specifically, radar data is used to estimate the amount of water present in a detected mass of hydrometeors.

SWE is the water equivalent of a mass of snow on the ground, i.e., snowpack. An early means of SWE estimation was through manual collection of snowpack depth and mass measurements. That is, an observer would assess the amount of snow in a particular location and use the measurements to estimate a SWE. Some ground stations still manually collect snowpack measurements and publish their SWE findings for general use. Other stations collect, store, and digitally transmit data in an automated fashion using remote sensors, as previously discussed.

The USDA Natural Resources Conservation Service (NRCS) collects snowpack and precipitation information, including SWE estimates, that are derived from manually collected snow courses and automated Snow Telemetry (SNOTEL) stations. Both current and historic SWE data are made available via a website for use in water management, decision making, and analysis. The NRCS makes such accumulated SWE data available as an interactive map or as tabulated data at https://nwcc-apps.sc.egov.usda.gov/imap/.

Other Government agencies and private companies also provide information about estimated or historical SWEs in table and map formats. For example, Airborne Snow Observatory, Inc. (ASO) uses LiDAR readings to measure snowpack and estimate SWE. ASO compiles data for areas requested under contract and provides maps of snow depth and SWE at www.airbornesnowobservatories.com. ASO also retains historical LiDAR data for parts of California, Wyoming, Oregon, and Colorado. Painter, et al. (2016) discloses technical and scientific aspects of SWE data collection by LiDAR and is incorporated by reference herein. Similarly, Parameter-elevation Regressions on Independent Slopes Model (PRISM) collects and maintains snow depth and SWE estimates in map and table formats, as described by Daly, et al. (1994), incorporated by reference herein. Snow depth measurements also can be derived from Synthetic Aperture Radar (SAR) satellites such as Sentinel-1, as described by Hoppenin, et al. (2024) and Lievens, et al. (2022), incorporated by reference herein.

Ground-based weather radar sensors, including S-, C-, and X-band radars, are also used extensively to collect data for SWE estimation. Weather radars typically scan a volume of atmosphere by making a 360 degree (°) scan at a particular tilt angle above the horizon, then increment to a steeper angle, make another 360° sweep, and so on. Once the entire volume is scanned, the radar returns to the original tilt angle and repeats the process. The time required to complete the scan is referred to as a revisit time step. Thus, maps of collected data for the volume of atmosphere surrounding the radar includes pixels of data at a defined spatial resolution projected onto the ground, and the time resolution is in units of the revisit time step.

While radar scanning provides valuable information for SWE estimation, the interpretation of radar data is challenging in a number of important contexts. For example, radar data is poor for distinguishing between large and small drops of rain, it is generally unable to detect mixed precipitation with both solid and liquid phases, and is unable to distinguish between wet snow and dry snow. Crucially for SWE estimation, radar data is particularly poor for identifying snow when the snow has high water content. Such deficiencies have been partially addressed by the use of dual-polarized (dual-pol) radars, which transmit and receive signals that are polarized in both horizontal and vertical directions. Dual-pol radar data is better for distinguishing between hydrometeor types, and can be used to estimate the density of frozen hydrometeors.

Data gathered from weather radars, particularly dual-pol radars, are currently used to estimate SWE (WRSWE). What is more, recent advances in radar polarimetry have produced high quality radar data for several geographic locations and a handful of weather events. Using this data, scientists have developed equations to estimate WRSWE, e.g., Bukovtid, et al. (2020), which is incorporated by reference herein.

Unfortunately, neither the Bukovtid equations, nor the data required to inform those equations, is practical for comprehensive and accurate SWE estimation. For example, the Bukovtid equations were developed using S-band radar data and include other measured parameters that must be supplied. The necessary measurements for such equation parameters are generally only collected by ground measurement stations, e.g., SNOTEL stations, which are absent or sparsely distributed in most areas requiring SWE estimates. Using the Bukovtid equations also requires specialized observations from a 2D Video Disdrometer that must be deployed to each area needing a SWE estimate, which is also highly impractical. Further, when WRSWE estimates calculated using the Bukovtid equations have been compared to SNOTEL data, they have proven to be highly inaccurate. Such shortcomings result in WRSWE estimates that are localized in area and time, and are not useful for accurately estimating SWE on a large scale, over an entire snowfall season, or across multiple watersheds. As such, current methods used to estimate SWE, particularly WRSWE, are inadequate.

Therefore, a dire need exists for improved SWE estimates that are accurate over broad geographic areas, such as over multiple watershed areas, and that can aggregate SWE amounts over entire snowfall seasons. The derivation of such estimates needs to improve use of ground-based weather radar and LiDAR data, and should be minimally reliant on physical parameter measurement at ground stations, allowing SWE estimates that include remote or inaccessible areas.

These and other deficiencies of the prior art are addressed by one or more embodiments of the disclosed invention, which includes a method and system for providing more accurate and comprehensive SWE estimates for improved water management for human consumption and overall environmental health. Benefits of the disclosed invention include improved avalanche-hazard determination; agricultural irrigation; flood mitigation; water resources supply and management; hydropower management; terrain and landscape ecological analysis; and weather forecasting. It also provides a tool for monitoring and studying climate change.

Additional advantages and novel features of this invention are set forth in part in the description that follows, and in part will become apparent to those skilled in the art upon examination of the following specification or may be learned by the practice of the invention.

### BRIEF DESCRIPTION OF THE DRAWINGS

Features and objects of the present invention and the manner of attaining them will become more apparent, and the invention itself will be best understood, by reference to the following description of one or more embodiments taken in conjunction with the accompanying drawings attached following this description.

FIG. 1 is a block diagram showing a generalized computer system, as used in embodiments of the disclosed invention.

FIG. 2 depicts a map of a region of interest for SWE estimation, as used in embodiments of the disclosed invention.

FIG. 3 depicts a map of a region of interest with SWE estimation contours, as used in embodiments of the disclosed invention.

FIG. 4 depicts a region of interest for SWE estimation with weather radar, as used in embodiments of the disclosed invention.

FIG. 5 depicts a flow chart including at least a portion of a process for SWE estimation, as used in embodiments of the disclosed invention.

FIG. 6 depicts a flow chart including at least a portion of a process for SWE estimation, as used in embodiments of the disclosed invention.

FIG. 7 depicts a chart representing a hypsograph of CSWE, as used in embodiments of the disclosed invention.

FIG. 8 depicts a chart representing a hypsograph of RSWE, as used in embodiments of the disclosed invention.

FIG. 9 depicts a chart representing a hypsograph of Q values, as used in embodiments of the disclosed invention.

FIG. 10 depicts a table including values used to determine Q values for a hypothetical Year 1, as used in embodiments of the disclosed invention.

FIG. 11 depicts a table including values used to determine Q values for a hypothetical Year 2, as used in embodiments of the disclosed invention.

FIG. 12 depicts a graph of dimensionless ground SWE values for Years 1 and 2, as used in embodiments of the disclosed invention.

FIG. 13 depicts a graph of Q values versus dimensionless ground SWE values for Years 1 and 2, as used in embodiments of the disclosed invention.

FIG. 14A depicts a map of a region of interest with Q value contours for Year 1, as used in embodiments of the disclosed invention.

FIG. 14B depicts a map of a region of interest with Q value contours for Year 2, as used in embodiments of the disclosed invention.

FIG. 15 depicts a chart representing a comparison of radar SWE to ASO mean SWE, as used in embodiments of the disclosed invention.

FIG. 16 depicts a map of a region of interest showing potential siting locations for ground stations, as used in embodiments of the disclosed invention.

FIG. 17 depicts a chart representing a comparison of unit observed SWE to elevation intervals, as used in embodiments of the disclosed invention.

FIG. 18 a map of a region of interest showing SWE values, as used in embodiments of the disclosed invention.

The Figures depict embodiments of the disclosed invention for purposes of illustration only. One skilled in the art will readily recognize from the following discussion that alternative embodiments of the structures and methods illustrated herein may be employed without departing from the principles of the invention described herein.

### Definitions

Snow Water Equivalent (SWE) means the depth of water that would result if a mass of snow, or snowpack, melted completely, whether over a given region of interest, a watershed, or a specified location. SWE is typically shown in millimeters as calculated from the snow height times the vertically-integrated density.

Q-hypsograph or hypsograph or means a relationship between the Q factor and elevation bands for a given region of interest or watershed.

Hydrometeor means particulates of liquid or solid water in the atmosphere.

Disdrometer means an instrument used to measure the drop size distribution and velocity of falling hydrometeors.

### DETAILED DESCRIPTION

The invention described herein includes methods and systems providing for more accurate estimations of SWE from atmospheric measurements. In one embodiment, the disclosed invention uses weather radar data aloft to detect atmospheric conditions in an area, and then uses the data to estimate SWE. The SWE estimate is then projected onto the surface where the distribution and quantity of SWE are mapped for target areas. The resulting SWE map provides a durable relationship between detected precipitation and resulting ground accumulation, allowing superior SWE estimates. By accurately predicting ground accumulation from precipitation aloft radar data, the disclosed invention provides accurate SWE estimates in remote areas where little data is available to determine actual accumulation.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the disclosed invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Included in the description are flowcharts and block diagrams depicting examples of the methodology and components which may be used to provide automated decision-making. In the following description, it will be understood that each block of such illustrations, and combinations of blocks in such illustrations, can be implemented by computer program instructions. These computer program instructions may be loaded onto a computer or other programmable apparatus to produce a machine such that the instructions that execute on the computer or other programmable apparatus create means for implementing the functions specified in the illustration block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the illustration block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the illustration block or blocks.

Accordingly, blocks of the flowchart and block diagram illustrations support combinations of means for performing the specified functions and/or combinations of steps for performing the specified functions. It will also be understood that each block of the illustrations, and combinations of blocks in the illustrations, can be implemented by special purpose hardware-based computer systems that perform the specified functions or steps, or combinations of special purpose hardware and computer instructions.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

### Computer System

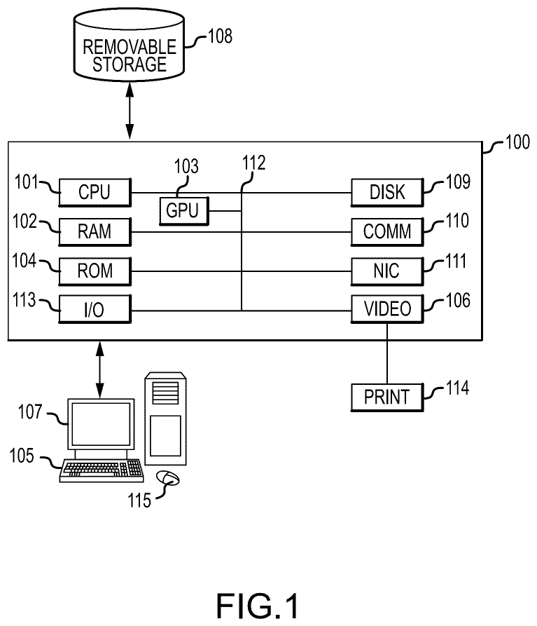

One having skill in the art will recognize that portions of the disclosed invention may be implemented on a specialized computer system, or a general-purpose computer system, such as a personal computer (PC), a server, a laptop computer, a notebook computer, or a handheld or pocket computer. FIG. 1 is a general block diagram of a general-purpose computer system in which software-implemented processes of the present invention may be embodied. As shown, the system 100 comprises one or more central processing unit(s) (CPU) or processor(s) 101 coupled to a random-access memory (RAM) 102, a read-only memory (ROM) 104, a keyboard or user interface 105, a display or video adapter 106 connected to a display device 107 (e.g., screen, touchscreen, or monitor), a removable storage device 108 (e.g., flash drive, floppy disk, cloud storage, etc.), a fixed storage device 109 (e.g., hard disk, flash memory), a communication (COMM) port(s) or interface(s) 110, and a network interface card (NIC) or controller 111 (e.g., Ethernet, wi-fi, cellular, near-field communication, etc.). Some embodiments include a graphics processing unit(s) (GPU) 103. Although not shown separately, a real time system clock is included with the system 100, in a conventional manner.

The CPU 101 comprises a suitable processor for implementing the present invention. In some embodiments, a GPU 103 may supplement computational tasks as is known in the art. The CPU 101 communicates with other components of the system via a bi-directional system bus 112, and any necessary input/output (I/O) controller 113 circuitry and other “glue” logic. The bus, which includes address lines for addressing system memory, provides data transfer between and among the various components. RAM 102 serves as the working memory for the CPU 101. ROM 104 contains the basic I/O system code (BIOS), which is a set of low-level routines in ROM that application programs and the operating systems can use to interact with the hardware, including reading characters from the keyboard, outputting characters to printers 114, etc.

Mass storage devices 108, 109 provide persistent storage on fixed and removable media, such as magnetic, optical, or magnetic-optical storage systems, flash memory, cloud servers, or any other available mass storage technology. The mass storage may be shared on a network, or it may be dedicated mass storage. As shown in FIG. 1, fixed storage 109 stores a body of program and data for directing operation of the computer system, including an operating system, user application programs, driver, and other support files, as well as other data files of all sorts. Typically, fixed storage 109 serves as the main data storage for the system.

In operation, program logic (including that which implements methodology of the disclosed invention described herein) is loaded from the removable storage 108 or fixed storage 109 into the main (RAM) memory 102, for execution by the CPU 101. During operation of the program logic, the system 100 accepts user input from a keyboard and pointing device 115, as well as speech-based input from a voice recognition system (not shown). The user interface 105 permits selection of application programs, entry of keyboard-based input or data, and selection and manipulation of individual data objects displayed on the screen, touchscreen, or display device 107. Likewise, the pointing device 115, such as a mouse, track pad, track ball, pen device, or a digit in the case of a touchscreen, permits selection and manipulation of objects on the display device. In this manner, these input devices support manual user input for any process running on the system.

The computer system 100 displays text and/or graphic images and other data on the display device 107. The video adapter 106, which is interposed between the display 107 and the system bus, drives the display device 107. The video adapter 106, which includes video memory accessible to the CPU 101, provides circuitry that converts pixel data stored in the video memory to a raster signal suitable for use by a display monitor. A hard copy of the displayed information, or other information within the system 100, may be obtained from the printer 114, or other output device.

The system itself communicates with other devices (e.g., other computers, other networks) via the NIC 111 connected to a network (e.g., Ethernet network, wi-fi, near field communication network, etc.). The system 100 may also communicate with local occasionally connected devices (e.g., serial cable-linked devices) via the COMM interface 110, which may include a serial port, a Universal Serial Bus (USB) interface, or the like. Devices that will be commonly connected locally to the interface 110 include desktop computers, laptop computers, handheld computers, etc.

The system may be implemented through various wireless networks and their associated communication devices. Such networks may include mainframe computers, or servers, such as a gateway computer or application server which may have access to a database. A gateway computer serves as a point of entry into each network and may be coupled to another network by means of a communications link. The gateway may also be directly or indirectly coupled to one or more devices using a communications link or may be coupled to a storage device such as a data repository or database.

### SWE Estimation

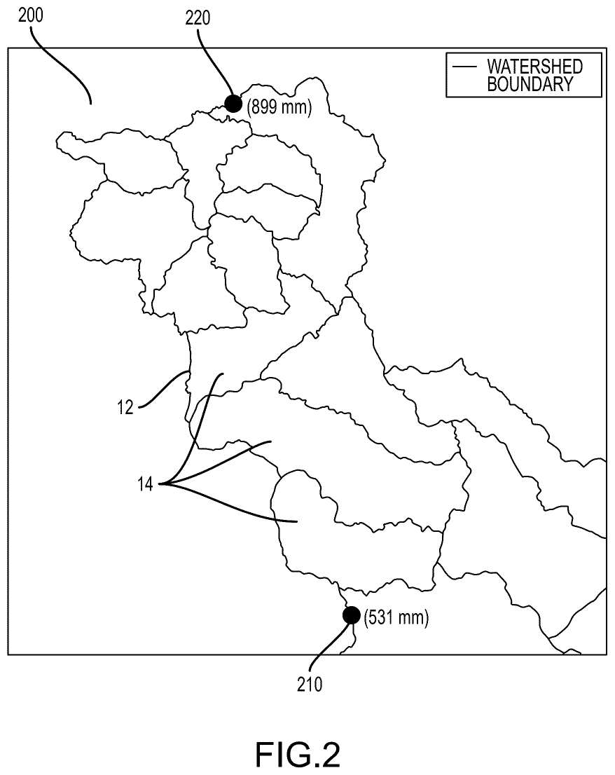

The disclosed invention includes systems and methods for developing maps of highly accurate SWE estimates. With reference to FIG. 2 is depicted an exemplary region of interest (ROI) 200 for SWE estimation. Various watershed boundaries 12 within the ROI are shown to delineate separate watershed areas 14. The ROI includes a SNOTEL station 210 that is equipped to make ground measurements of SWE in the local vicinity of the station. Another location 220 is without a nearby SNOTEL station, and therefore no ground measurement-based SWE estimate is possible at that location. As is the case with most areas, the ROI 200 is not overflown by airborne LiDAR sensors, making LiDAR data unavailable. However, the ROI is covered by a weather radar installation 220. The weather radar collects data that is used to make a WRSWE estimation for the location 220. At the end of the snow season for this ROI, the SNOTEL station 210 makes a final SWE measurement of 531 millimeters (mm), while the final WRSWE estimate for location 220 is 899 mm. Typically under the current state of the art, no SWE estimates are made for the remainder of the ROI 200, and therefore SWE estimates will be inaccurate for watersheds 14 between the locations 210, 220.

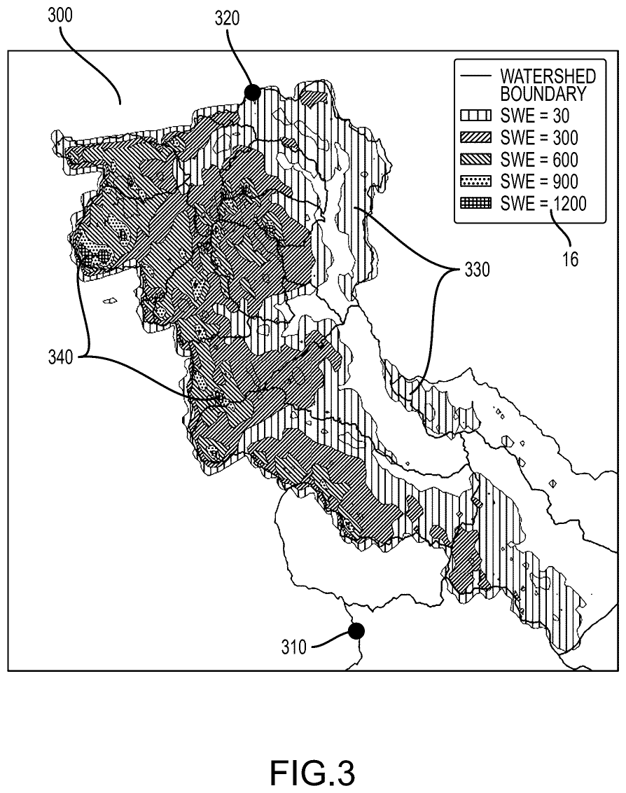

Using the disclosed method, however, a superior SWE estimate is made for watersheds 14 between the locations 210, 220, and thus a more comprehensive SWE map of the ROI is developed. With reference to FIG. 3, the ROI of FIG. 2 is shown with an overlaid SWE contours using SWE estimates developed using the disclosed invention. The ROI 300 includes the SNOTEL station 310 and weather radar station 320 from the previous figure. The SWE map depicts various SWE amounts accumulated on the ground for an entire snow season within the ROT. The estimated SWE amounts are designated by color or pattern and are contoured according to ground coverage of the various amounts. A key 16 indicates example SWE amounts in millimeters of depth, which range from 30 SWE in lighter areas 330 to 1200 SWE in the darkest areas 340. SWE estimates are computed using a grid of radar pixels spaced, for example, at 1 degree azimuth by 300 meters in range of the radar or interpolated into a finer resolution as appropriate to capture the spatial resolution of the SWE distribution on the ground.

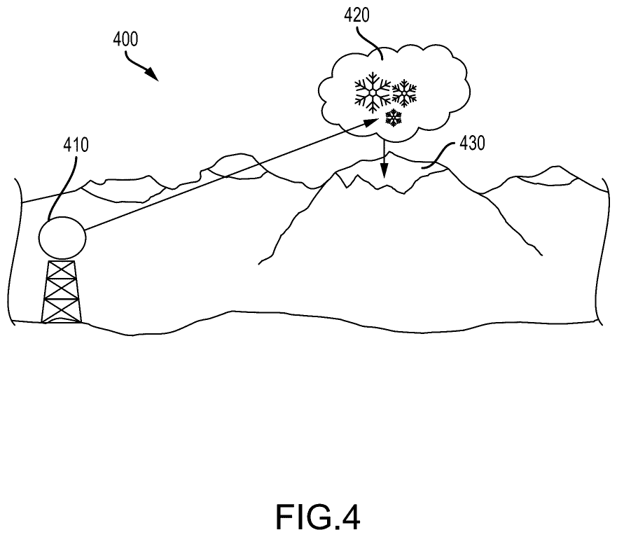

With reference to FIG. 4, a region of interest 400 is depicted in which a ground weather radar 410 is available to scan precipitation aloft 420 to estimate the amount of precipitation that will accumulate on the target area surface 430 as mapped onto the ground from the collected radar data. The types of radars used may include S-, C-, or X-band, and may be a dual-polarization radar. The radar 410 may include one, more than one, or an array of radar units. The radar may be set to multiple tilt angles, each of which permits the radar to scan a segment of atmosphere above the target area 430, each segment corresponding to a vertical range or slice of altitude. By setting a radar tilt angle to collect data, and/or examining data collected at the radar tilt angle, a desired altitude range above the target area 430 is examined. An altitude range of particular interest for SWE estimation is the dendritic growth layer, which is where snow typically forms, and is generally located between isotherms of −10 degrees Celsius (° C.) and −20° C. Alternatively, a radar may be configured to scan a larger vertical slice of altitude that includes multiple layers of the atmosphere. When taking a larger slice of altitude, the tilt angle may need to be adjusted to minimize or avoid ground returns while capturing the snow producing layers in the atmosphere above the target area.

The radar 410 scans produce data from which atmospheric measurements are extracted using algorithms known in the art. For example, snow particle size distribution is derived from radar moments that include specific differential phase (K_{DP}), differential phrase (Z_{DR}), reflectivity difference (Z_{DP}) and vertical (dBVZ) and horizontal (dBHZ) reflectivities, the reflectivities in linear units of mm⁶/m³. The radar itself also has characteristics that affect the interpretation of collected data, such as the microwave beam wavelength λ. Using collected data and radar characteristics, and presuming certain constants and parameters, the WRSWE may be computed using the Bukovčić equation:

$$WRSWE = ( \frac{3.6}{{4}^{{δ}_{1}}} {d}_{1} {( \frac{{p}_{0}}{{p}_{a}} )}^{0.5} \frac{Γ ( 4 - {B}_{1} + {δ}_{1} )}{Γ ( 4 + {B}_{1} )} ) * ( 3.96 \cdot {10}^{- 3} \frac{{K}_{DP} λ}{( 1 - {Z}_{DR}^{- 1} )} ) * {( - 0.1 + 2 {( \frac{{Z}_{DP}}{{K}_{DP} λ} )}^{1 / 2} )}^{{δ}_{1}}$$

Wherein
α₁ and B₁ are parameters in the particle density power law relation, ρₛ(D)=α₁D^{B}^{₁};
σ is the width of the canting angle distribution, which is related to precipitation drop orientation;
δ₁ and d₁ parameters in the terminal velocity relationship,

$${V}_{t} = {d}_{1} \cdot {( \frac{{p}_{0}}{{p}_{a}} )}^{0.5} \cdot {D}^{{δ}_{1}} ;$$

pₒ is the atmospheric pressure at mean sea level;
pₐ is the atmospheric pressure at the target location (e.g., FIG. 4, item 430);
λ is the wavelength of the radar;
Z_{DP} is the difference between vertical reflectivity and horizontal reflectivity;
Z_{DR} is the differential phase, i.e., the difference between horizontal reflectivity and vertical reflectivity in linear units; and
Γ is the gamma function, a generalization of the factorial function to non-integer numbers.

The parameters α₁, B₁, δ₁, d₁, and σ, known as microphysics parameters, correspond to physical attributes of atmospheric phenomena, such as precipitation transiting the atmosphere. Microphysics parameters, especially α₁, B₁, and σ, are often not directly measurable, and must be inferred from disdrometer studies. Unfortunately, there have not been enough of such studies, in enough atmospheric contexts, to allow practical or large-scale SWE estimations. Nevertheless, some values for these parameters have been obtained from direct experimentation, e.g., ranges for α₁ and d₁ have been derived from studies published by Brandes, et al. (2007 and 2008), incorporated by reference herein. WRSWE estimates computed using the Bukovčić equation often do not accurately reflect the observed SWE amounts measured by ground stations when the two methods are compared. There may be discrepancies between WRSWE observed aloft and ground observations at sensor locations due to the local enhancement or depletion of snow accumulation due to various processes that either diminish or increase precipitation as it falls through the atmosphere to the ground. Similarly, the discrepancies may also be caused by processes that cause local enhancement or depletion of snow accumulation after it reaches the ground, namely wind redistribution of snowfall, drifting, orographic enhancement, leeward deposition, windward erosion, sublimation or ablation, and melting.

The disclosed invention uses radar data and other inputs to develop a corrected WRSWE (CSWE) that more accurately corresponds to SWE values observed on the ground. Once derived, CSWE values may then be provided on maps, such as that depicted in FIG. 3, or tabulated into charts for use. CSWE values may also be used to characterize relationships between certain physical phenomena.

### Corrected WRSWE Estimates

To develop CSWE values, the invention relies on use of a Q-factor, or Q, which is defined to represent the ratio of the CSWE to an observed or developed reference SWE (RSWE). That is, Q=RSWE/CSWE. Through the disclosed invention, Q is optimized and designated Q₀, which is an efficient, highly accurate, and elegant solution to improving SWE estimates based on radar data. Q₀ relates to the manifestation of certain physical phenomena which create errors in WRSWE. Those physical phenomena include 1) depletion of snow mass, e.g., by wind redistribution, drifting, windward erosion, sublimation, and ablation, and 2) accumulation of snow mass, e.g., by wind redistribution, drifting, orographic enhancement, and leeward deposition. Once Q is determined, it is used with optimized microphysical parameters to provide accurate and representative maps of SWE distribution over a target area.

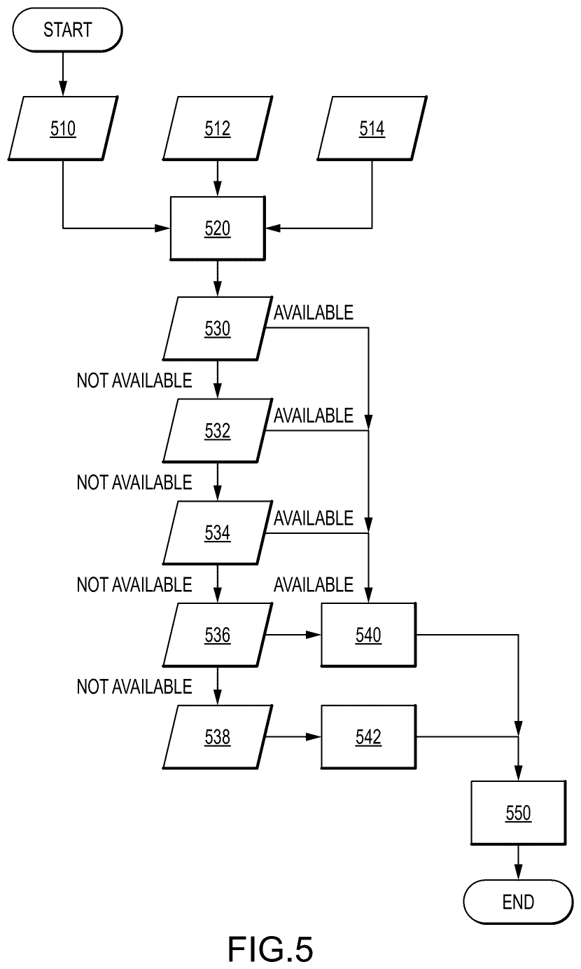

With reference to FIG. 5, an exemplary flow chart shows a process for developing a CSWE value according to an embodiment of the disclosed invention. First, the method uses a number of inputs to perform the CSWE estimation. Inputs include radar data 510, which includes collected atmospheric data, such as K_{DP}, Z_{DP}, and Z_{DR}, and the radar wavelength λ, which is a constant for the collected data determined by the radar equipment deployed. Other inputs include microphysics parameters 512, such as α₁, B₁, δ₁, d₁, and σ, that are used in some embodiments. In some embodiments, ancillary inputs 514, such as atmospheric temperature and pressure measurements, are used as well. Ancillary data inputs may be derived from numerical weather prediction models commonly employed in weather forecasting and are available in archival formats as maps that correspond to the target areas selected for SWE estimation.

Each radar collection instance i generates a set of radar data over a period, at time steps determined by the rotational speed of the radar and its scanning strategy, i.e., the revisit time step. The data collected at time i is measured at regular intervals in space, typically at 1 degree azimuth and 1 km or less in range from the radar. The array of data with a set of data for each instant in time comprises the radar data 510.

In a WRSWE computation step 520, each set i of radar data is used with the radar wavelength λ, microphysics parameters 512, and optionally ancillary data 514, to compute an ith instance of WRSWE, designated WRSWEᵢ. The computation step may use the Bukovčić relation to generate a WRSWE, or other suitable method.

Next, a reference SWE (RSWE) value 530, 532, 534, 536, is provided for analysis against the calculated WRSWE. Each RSWE is presumed to be an accurate, or more accurate, measurement of the SWE than WRSWE, for example as measured on the ground in a target location. Preferably, the RSWE may be a SWE at a target location as computed from LiDAR data 530. LiDAR-based SWE computations may be obtained from independent providers such as the Airborne Snow Observatory, Inc. (ASO).

LiDAR-based SWE 530 is the preferred observation to provide a RSWE, however, if no LiDAR RSWE is available, an alternative reference SWE 532, 534, 536 may be used instead, in descending order of preference. In the absence of a LiDAR-based RSWE, a ground station observation 532 is used, if no ground station data is available, snow deposition maps and models 534 are used, if these are unavailable, SWE information is entered from a predetermined distribution of SWE values for each region 536. If none of the above RSWE values are available, a constant Q value (Q_{c}) is adopted 538, rather than using an RSWE.

If a map of RSWE values is available, a loss function optimization step 540 determines a loss function value L based on the difference between WRSWEᵢ and the available RSWE. That is, L=WRSWEᵢ−RSWE. Then, L is minimized as a function of Q, α₁, B₁, δ₁, d₁, and σ: Lmin=f (Q, (α₁, B₁, δ₁, d₁, σ), to derive optimized parameter values designated as Q₀, α₀, B₀, δ₀, d₀, and σ₀. Q₀ is then mapped to a geographic depiction of the ROI by the following process. A coordinate grid is overlaid on the ROI using, e.g., latitude and longitude. Each location j where Q₀ is determined is oriented on the grid, and Q₀ values in areas between locations with known Q₀ values are estimated by interpolation. The microphysics parameters may be mapped in a similar manner, or the spatial average of each parameter may be computed over the ROI.

Next, using these optimized parameters calculated in step 540, a map of corrected WRSWE (CSWE) is generated in the CSWE calculation step 550. For each location j, the optimized microphysics parameters α₀, B₀, δ₀, d₀, and σ₀, as determined in 540, are used in the Bukovčić relationship to determine an optimized WRSWE for the location. Then, using the mapped Q₀ values, CSWE is calculated and mapped by multiplying the optimized WRSWE by the Q₀ value, or interpolated Q₀ value, at locations across the ROI to determine the CSWE at each location. This information may be used to create charts or maps, such as the map depicted in FIG. 3.

This process is termed “forward generation” when predetermined parameters are used to generate CSWE. While some embodiments use the Bukovčić relationship to calculate CSWE, other embodiments use other suitable relationships, for example, the relationship discussed in Capozzi, et al. (2020), which is incorporated by reference herein.

### L Optimization

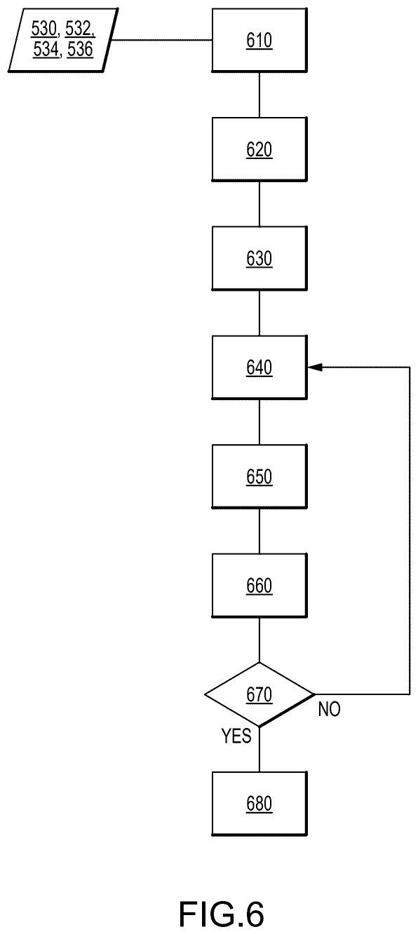

In one embodiment, an optimization algorithm is used to perform the L optimization step 540. With reference to FIG. 6, the optimization algorithm receives RSWE inputs from one of LiDAR 530, ground station observation 532, snow deposition maps from Synthetic Aperture Radar satellites or models 534, or regional climatological SWE maps such as PRISM values 536 and proceeds to a collection step 610. In the collection step, a set of radar moments, e.g., K_{DP}, Z_{DR}, and dBZ measured by radar at a point in time, are derived from collected data.

Next, in an assembly step 620, the measurements to be used as RSWEs are assembled. For example, if the values are LiDAR measurements, the assembly step 620 assembles the LiDAR data to be used as RSWEs. Next, in an initial value step 630, initial values and permissible ranges for each of the physical parameters α₁, B₁, δ₁, d₁, σ are assigned. Initial values and permissible ranges are selected from physically realistic ranges and averages reported in the scientific literature, namely Brandes, et al., 2007, 2008. As a control on the optimization, the values of Q may be allowed to vary from 0-10 or other reasonable ranges as derived from studies in the same or geographically diverse localities.

Next, in steps 640 through 660, the value for each of the physical parameters is iteratively varied beginning from its assigned initial value to the bounds of the permissible range, and WRSWE is computed. That is, a baseline WRSWE is computed for the values of the physical parameters as determined by the initial values 640, then the varied values are used to calculate an adjusted WRSWE 650, and then an L value for the adjusted WRSWE is determined 660. The L value is then compared 670 to a desired error range L≤0±ε, wherein c is an acceptable amount of error for the process, e.g., 15%, 10%, 5%, or other suitable error amount. If the error is outside the acceptable range, the process is repeated from 640 to 660, each time iteratively varying the values of each of the physical parameters, and computing the respective adjusted values for WRSWE and L until the error in L is within the acceptable error range.

When the L error is within the acceptable range, the adjusted WRSWE is selected as the WRSWE. Then the values of the optimized physical parameters corresponding to the minimized L are tabulated 680 as α₀, B₀, δ₀, d₀, and σ₀ and the optimized Q is designated Q₀.

In some embodiments, the optimization algorithm is used to optimize L at frequent intervals during a snow season. In the collection step, therefore, a time series of radar moments, e.g., K_{DPi}, Z_{DRi}, and dBZᵢ measured by radar at a time step, i, are derived from collected data. These values may be selected based on the update frequency of the radar, or may be aggregated over a regular time step, e.g., 5-minutes, 15 minutes, 1-hour, etc., for the period of interest. The period of interest (POI) is a duration over which the SWE estimate is taken, for example, a single weather event, a week, a month, a snowfall season, a year, etc. At the end of the POI, the RSWE is measured on the ground. If taken in the form of ground station measurements, RSWE may be measured at regular time steps of 5 minutes, hourly, or daily. If measured by LiDAR, RSWE may be measured less frequently, for example, weekly, monthly, or once at the end of the snow season. In the assembly step 620, the measurements to be used as RSWEs for each time step i are assembled before the initial value step 630 is performed for the first time step. Then steps 640 through 660 are performed and WRSWEᵢ is computed for each time step i. Then the WRSWEᵢ for each time step is used to construct a cumulative time series of WRSWEᵢ. The last time step may correspond to the end of an entire snow season or an intermediate period such as a week, month, or several months.

Other computation methods are known for optimization including sequentially varying the function parameters by Sequential Least Square Programming as presented in Kraft (1988), incorporated by reference herein. Further, other methods for minimizing L may be used. For example, machine learning methods such as neural network applications may be used to guide the learning of new parameters, guided by the principles of physics, to find optimized values of the physical parameters which would minimize the loss function.

Far from being a mere bias correction for WRSWE, the Q value used in the disclosed method has physical significance. Through the process of minimizing the loss function (L) for the denoted microphysics parameters and Q, the Q₀ hypsograph captures a predictable relationship between real-world SWE accumulation on the ground and radar-derived SWE accumulations as detected aloft. The Q₀ values provided by the disclosed invention transform radar data, which is nevertheless the most widely available type of SWE data, from a deficient SWE estimation tool into accurate and useful data for water resource management.

### Alternative RSWE Sources

The disclosed invention is preferably used with LiDAR data to provide reference SWE (RSWE) values. However, LiDAR information is not available for all regions, and further may not be available for the particular time required. For example, only one LiDAR overflight may be scheduled for a region of interest during peak SWE dates in April or May, but water managers require earlier and more frequent RSWE values during this period. In such cases, the disclosed method may be used with alternative RSWE values. With further reference to FIG. 5, if LiDAR data 530 is not available, then ground station data 532 is used. Ground station SWE data is obtained manually by personnel taking field measurements of snow depth and density in the vicinity of the ground station. Such data is then used to compute a SWE value. Ground station data may be observed in situ or obtained from other sources, such as SNOTEL stations. SNOTEL data is collected and disseminated by the USDA Natural Resources Conservation Service and the National Water and Climate Center. SNOTEL data is only sparsely measured and will not represent the SWE over an entire region of interest.

If ground station data 532 is unavailable, other alternative sources 534 for RSWE data include mapping and modeling of snow deposition patterns from a variety of sources, including the following: PRISM maps (Daly, et al. 1994); computational fluid dynamic-derived maps of snow deposition by wind in complex terrain (Vionnet, et al. 2021); snow depth mapping in high-alpine catchments using digital photogrammetry (Bühler, et al. 2015); snow depth retrievals from SAR backscatter for remote monitoring of seasonal snow (Lievens, et al. 2022; Hoppinen, et al. 2024); airborne ultra-wideband (UWB) frequency-modulated continuous wave (FMCW) radars (Kolpuke et al. 2022); snow-transport models for simulating wind-related snow distributions over a range of topographic and climatic environments (Liston, et al. 2007); or any other suitable technology that can describe, with sufficient accuracy, the distribution of ground snow depth and coverage. Such methods used to describe snow depth may be converted to RSWE by comparison with ground stations such as SNOTEL, and by auxiliary modeling of the snowpack properties that accounts for the density of snow layers and losses due to sublimation and melting. Such auxiliary snowpack modeling used to estimate snowpack density include iSnobal (Marks, et al. 1999) and SnowModel (Liston and Elder, 2006); each of which are incorporated by reference herein.

In some regions and for a particular temporal range, none of the above sources of RSWE 534 may be available or reliable. In such cases, an SWE distribution may be assumed based on known data for the relevant region 536. The distribution of SWE is approximated by setting a maximum SWE value at an elevation at or below the peak ridge elevation upwind of the target area. From this maximum SWE value, SWE distribution is modeled by gradually decreasing SWE for lower elevations until zero accumulation is anticipated at the “snowline,” an elevation below which snow does not form due to melting or persistent elevated temperatures. The relationship between elevation, snow depth, and SWE is analyzed by means of a hypsograph (Grünewald, et al. 2014). Such a method of modeling SWE distribution approximates the unknown Q-hypsograph distribution and is referred to as an Assumed SWE Distribution.

SWE distributions and Q-hypsographs may be generated using the disclosed invention for use as an RSWE. Other SWE distributions have been created and published based on measured data or other estimation methods. While such sources of RSWE data are generally inaccurate, see Vionnet, et al. (2021) or Sexstone, et al. (2018), when used to develop the Assumed SWE Distribution and RSWE values as part of the disclosed method, they still contribute to useful SWE estimates as compared to existing SWE estimation methods.

As yet another alternative RSWE source, if assumed SWE data 536 data is unavailable, Q is assumed to be constant, Q_{c} 538. In the event no assumptions about SWE distributions are possible, Q is left undefined, requiring Q to be derived from similar target areas or studies where the Q-hypsography is known. In such cases, a mean value Q_{c} is applied 542. For example, if Q_{c}=1.0 is applied, then the deposition of SWE over the target area is assumed to be equal to radar SWE. Similarly, if Q_{c}=2.0 then ground SWE is assumed to be 2X radar SWE. Accordingly, in step 542 no loss function is defined or optimized as it was for other RSWE sources in step 540. Instead, each of the microphysics parameters are averaged over all of the instances of the WRSWEᵢ and returned as α₀, B₀, δ₀, d₀, and δ₀, while Q₀ is set to Q_{c}. These values are then used in the CSWE computation step 550 to derive the CSWE, which is the corrected WRSWE, but with an assumed Qc.

While FIG. 5 depicts the evaluation of RSWE source availability according to a preferred order, in some embodiments, no particular order is required. RSWE sources may be evaluated for availability in a step-by-step manner according to the depicted order, or in some embodiments the selection process may evaluate fewer or additional RSWE sources. Alternatively, an RSWE source may be preselected based on various criteria.

In the absence of LiDAR, PRISM, or SAR data, one embodiment uses a ground measurement 532 from the closest SNOTEL station to perform the optimization sequence of FIG. 6. The forward estimation of CSWE 550 is performed with the optimized values of α₀, B₀, δ₀, d₀, σ₀, and Q₀, as determined in 540. When Q₀ is determined from a single ground measurement, additional information is required to construct a map of CWSE values, namely the relationship between Q and elevation for the region of interest. This relationship is a Q-hypsograph described below.

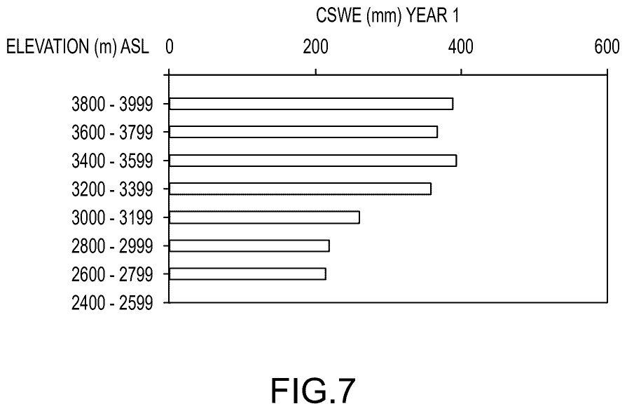

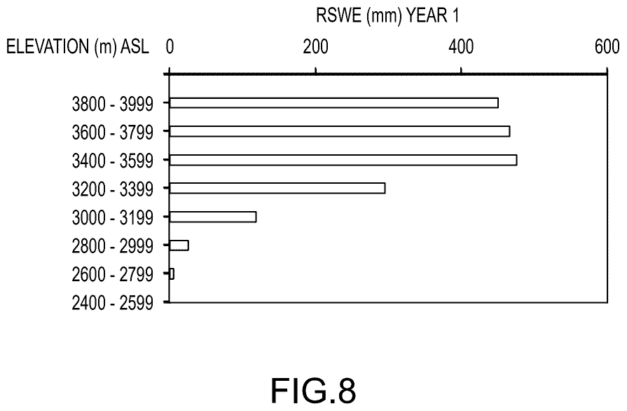

Examining Q factor values informs the fraction of accumulated precipitation depth derived from WRSWE data as compared to accumulation caused by local wind redistribution of the precipitation, such that when WRSWE and Q are multiplied together, the water resource amount as predicted by WRSWE agrees with the total accumulation on the ground. In other words, Q modifies accumulation estimates based on radar data with accumulation from ground effects and local redistribution of the precipitation on the ground. The spatial distribution of Q₀ can then be inferred from an assumed Q-hypsograph, PRISM, or SAR. The spatial distribution of Q₀ may be used with WRSWEs to create an accurate spatial distribution of SWEs in various elevation bands, e.g., 2400-2600, . . . , 3800-3900. The Observed hypsography derived from the optimization process in FIG. 6 is shown in FIG. 7 for CSWE (in mm), and in FIG. 8, for the RSWE (in mm), which may equivalently be derived from PRISM, SAR, or LiDAR.

In short, when Q₀ factor for a particular location is applied to a WRSWE, the result is a more accurate prediction of the snow water equivalent accumulated on the ground. CSWE is better approximated by Q₀ times WRSWE than any other predictive method based on weather radar data alone. Therefore, Q factor allows accurate estimates of SWE to be derived from weather radar data.

An accurate SWE map accounts for various factors and processes that affect the depth of SWE measured on the ground, including wind redistribution of snowfall, drifting, orographic enhancement, leeward deposition, windward erosion, sublimation or ablation, and melting. As such, SWE is an important tool that may be applied in a variety of fields.

One such application is mapping the deposition of aerosols comprising black carbon, mineral dust, or other impurities that diminish the snow's reflectance and adsorption of solar radiation, referred to as albedo. Changes in albedo due to aerosol deposition results in increased snowmelt rates and reduced snowpack cover, which in turn affects water supply volume and its effective management. Climate change is exacerbating variability in snow water supply, making mapping and measurement of snowpack and related characteristics such as albedo critically important. See, e.g., Hale, et al. (2023), incorporated by reference herein. SWE mapping may also improve the identification of avalanche risk. The Q-hypsograph could be used to estimate SWE on steep slopes where the disclosed invention improves knowledge of depth and depositional patterns caused by terrain and local wind patterns.

### Temporal Evolution of Q-Hypsography

With further reference to FIG. 4, the disclosed invention includes a method of developing a Q-hypsography for a given region 400. Q₀ corresponds to a first volume of atmosphere at the target area 420, namely the volume which is scanned by the radar. It also corresponds to the location 430 where snow accumulated. In other words, Q₀ is specific to grid location 430 for which the radar data, WRSWE was collected and for which the reference or RSWE was obtained.

Each location j 430 in region 400 may have its own Q₀ computed based on its specific data: Q₀ⱼ. These Q₀ⱼ values may be generated for multiple locations or grids within one region or across many regions or watersheds. For example, other locations may be those adjacent to location 430. In this way, the collection of Q₀ⱼ provides a map of the region showing the Q₀ⱼ factors for a region or location. Because elevations within each region are known, the Q₀ⱼ thus obtained may be associated with the elevations of each location j in a region (or across multiple regions). In particular, Q₀ⱼ may be plotted against elevations to create a Q-hypsography of a region. In another embodiment, two component hypsographs may be used to analyze SWE in a region: one for CSWE aloft over the target location 430, and the other for SWE measured on the ground, i.e., an RSWE for that location.

With reference to FIG. 7 is depicted a hypsograph of CSWE for a season of accumulation in the region of interest FIG. 4, item 400 for a year designated Year 1. The y-axis shows the elevation interval, which ranges from the lowest elevation in the target area (2400 meters above sea level—2599 m), to the highest elevation interval or band (3800 m-3999 m). A hypsograph is formed by averaging the Q₀ values in grids with elevations that fall within each interval or elevation band. The x-axis shows CSWE estimates in millimeters (mm). The graph depicts a hypsographic analysis applied to CSWE detected aloft on the leeward side of a mountain ridge. Hypsography may be used to identify the distribution of CSWE measured by WRSWE and corrected with the Q-hypsograph, RSWE measured on the ground, and the ratio, Q₀ⱼ=RSWEⱼ/CSWE; where the jth value of Q₀ is the average of grids that fall within elevation band.

The value associated with the elevation band 3800 m-3999 m corresponds to the CSWEs for each location (j) in the ROI at this elevation band. There may be one or more elevation bands within the region. Where there are multiple such elevation bands, an average of the various CSWEs for each location within the elevation band may be used. Alternatively, a representative CSWE for the location, which would be the CSWE for the elevation of the location, may be estimated as disclosed herein.

For the purposes of FIG. 7, the CSWE represents the average CSWE for all locations j in the designated elevation band. For example, the elevation band 3800 m-3999 m had an average CSWE of 388.5 mm and the elevation band 3600 m-3799 m had 366.8 mm. At the lowest elevation interval 2400 m-2599 m and below, the average CSWE was zero. Elevations showing zero CSWE may either be below the snowline, or the atmospheric conditions of temperature, elevation, or pressure were not conducive to the formation of snowpack at those elevations. The lowest elevation band with zero CSWE may have weather radar data indicating precipitation, but the precipitation melted while falling or after it reached the ground. The lower elevation limit of SWE deposition may be deduced from the plurality of methods that include, snowpack modeling, satellite and airborne retrievals, and with the assistance of freezing level detected or estimated by horizontal or vertical pointing radars, radiometers, atmospheric profilers, or atmospheric and snowpack models.

With reference to FIG. 8 is shown the hypsograph of RSWE for the same elevation intervals in the ROI 400 for the same Year 1. The y-axis shows the same elevation intervals as in FIG. 7, which range from the lowest elevation (2400 m-2599 m) in the target area, to the highest elevation interval (3800 m-3999 m). The x-axis shows the RSWE measurements in millimeters (mm). RSWE corresponds to actual ground measurements of SWE at locations within the region.

In addition to using ground measurements as RSWE (or in the computation of CSWE), hypsographs also may be tabulated using LiDAR data, data from climatological maps of precipitation, satellite or airborne radar, or other sources. Climatological precipitation maps typically represent a monthly normal or annual normal depth. Adjustments of precipitation amounts may be considered, and may be made by using the disclosed methods, data from satellites, numerical weather prediction models, or any other means to make the climatological map more representative of SWE.

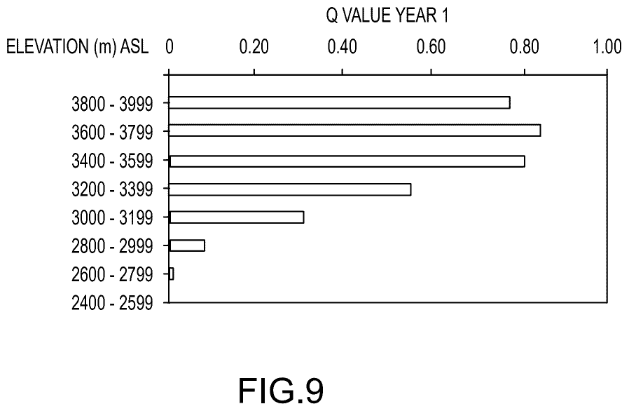

FIG. 9 contains the hypsograph of Q₀ shown as the ratio RSWE/CSWE from the hypsographs in FIGS. 7-8. The y-axis shows the same elevation intervals as in FIGS. 7-8, which range from the lowest elevation in the target area (2400 m-2599 m), to the highest elevation interval (3800 m-3999 m). The x-axis shows Q values, which are dimensionless. For example, the value of Q in region 3800 m-3999 m corresponds to the quotient of RSWE=306.3 mm and CSWE=388.5, which is Q=0.79. A value of Q<1.0 means that the SWE predicted from data aloft (CSWE) is more than actually present on the ground (RSWE). When Q>1.0, the SWE predicted from data aloft (CSWE) is less than is measured on the ground. Such discrepancies may be due many factors, but likely are primarily due to wind redistribution of accumulated SWE. A value of Q=0 indicates that despite precipitation measured aloft in a target area, no ground accumulation was observed, for example due to wind redistribution, sublimation, or melting.

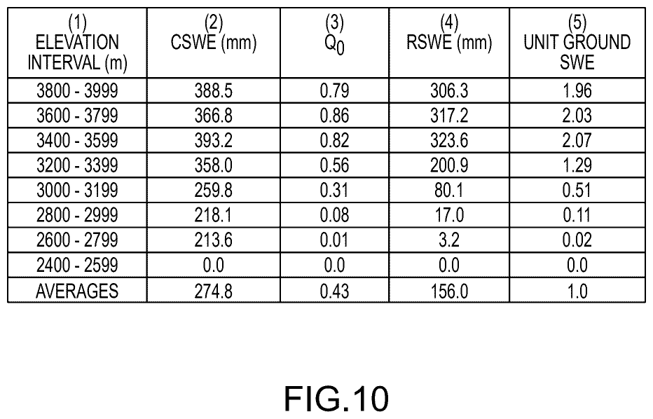

With reference to FIG. 10 is depicted a table that summarizes relevant information used in and generated by the method of FIG. 5, as calculated using data from Year 1 found in FIGS. 7-9. Relevant elevations in the region are shown in column (1). CSWEs are tabulated in column (2). Column (3) shows the Q₀ values derived from, e.g., FIG. 5, step 540. Column (4) tabulates the RSWEs used for each elevation band in the region. Column (5) is the ratio of each RSWE value in a particular elevation divided by the average RSWE as shown in the last row. As a computational check, the average of the Unit Ground RSWE values=1.0. In the last row of table, the averages are computed for non-zero values. Unit RSWE are dimensionless profiles of ground deposition. Although not shown in this table, CSWE may be placed in dimensionless form by dividing each CSWEⱼ by the average of non-zero values. Then the Q₀ may be computed by the ratio of [Unit RSWE]/[Unit CSWE] times the ratio of the averages, RSWE_{avg}/CSWE_{avg}. The average of Q₀ in column (3) shown in the last row is 0.43 in Year 1, which indicates that on average there was only 43% of SWE detected aloft that remained on the ground, [RSWE=156.0]/[CSWE=274.8].

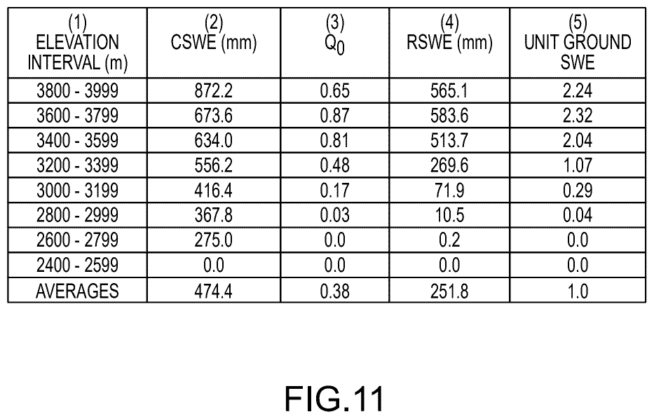

With reference to FIG. 11 is shown a table similar to that in FIG. 10, except that it includes data corresponding to a Year 2. The CSWEs in column (2) are the measurements from Year 2 but for the same region and same elevations as from Year 1. As can be seen from column (3), the Q factor for each elevation remains the same—as stationary points in the analysis—despite the changing data. As such, Q provides a durable tool for determination of accurate SWEs from radar data. Q value is related to the Unit Ground SWE in a nearly linear relationship, having a trendline slope equal to the ratio of radar-derived SWE to SWE measured on the ground, i.e., RSWE_{avg}/CSWE_{avg}. And further, even though the snow season produced more snow in Year 2 than in Year 1, the Q average (Q_{avg}) is very similar (within 5%) for both years: 0.43 for Year 1 and 0.38 for Year 2. Q values with Unit Ground SWE may be used prospectively to predict accurate SWE distributions and maps from SWE aloft, as derived from radar data.

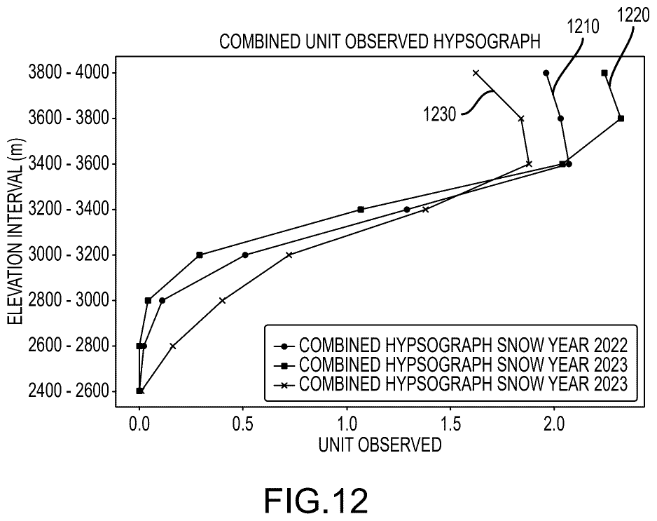

With reference to FIG. 12 is a graph that demonstrates the functional relationship between the elevation and the unit RSWE (dimensionless ground SWE) for the data contained in FIGS. 10-11. The y-axis shows the same basic elevation ranges from previous figures, which range from the lowest elevation in the target area (2400 m-2600 m), to the highest elevation interval (3800 m-4000 m). The x-axis shows dimensionless unit ground SWE. The SWE units were made dimensionless by dividing each SWE in an elevation band by the average of the SWE values in all elevation bands. As is apparent, there is a functional relationship between elevation and unit RSWE values since the graph for Year 1 1210, Year 2 1220, and Year 3 1230 are very similar in shape. Because these graphs are dimensionless, when there is less volume at lower elevations, the peak compensates for this by presenting higher values at higher elevations. Note that Q-hypsographs of this relationship are not linear. However, if Q is plotted versus Unit Ground SWE, both years present a linear functional relation between Q and the unit RSWE, with slope equal to Q_{avg} that passes through the origin.

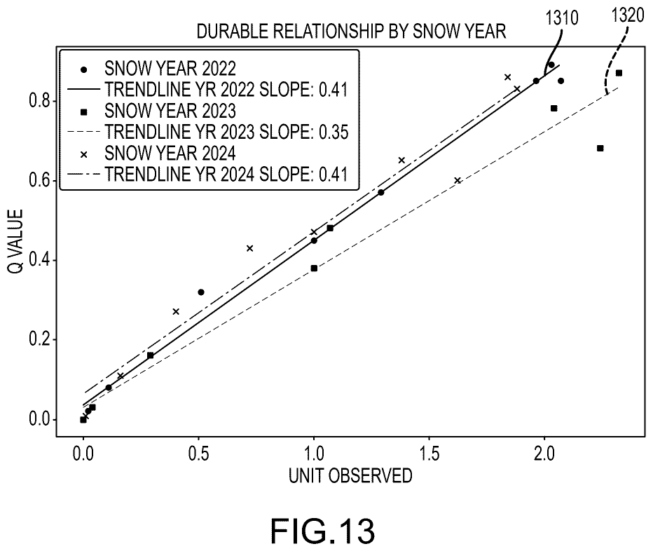

With reference to FIG. 13 Unit Observed RSWE is plotted against Q for the data contained in FIGS. 10-11. The y-axis shows the dimensionless Q factor, while the x-axis shows unit RSWE. Each point on the plot corresponds to an elevation in the region. Points from Year 1 are plotted and fit to line 1310, while points from Year 2 are plotted and fit to line 1320. The slope of each trendline is approximately the Q_{avg} in each year. That is, at each elevation, the change of Q with respect to the RSWE is equivalent to the ratio of the average RSWE to the CSWE, which is substantially constant. Conversely, at each elevation, the discrepancy between the predicted SWE as obtained from weather radar data can be accurately, and durably, identified by Q_{avg}. Q therefore allows calculation of a CSWE that accurately uses radar data to identify the water equivalent of the precipitation that has accumulated on the ground. Note that the plots in FIG. 13 pass through the origin, indicating that CSWE and RSWE are correlated when grouped by elevation band.

### Applications of Q Analysis

In addition to providing a means to estimate SWE, various Q factors can be used to model the projection of atmospheric phenomena onto the ground and to understand the effect of such phenomena, especially with respect to water resources. For example, Q factor distributions may be performed continuously throughout the snow season, for example from LiDAR RSWE measurements, to provide ongoing SWE estimates.

Rather than using an RSWE value taken at a particular time, Q may be determined from a composite RSWE value. When a Q factor is calculated from an RSWE, the Q is only applicable to the particular time the underlying RSWE was observed. Typically, RSWE is observed at the end of the snowfall season, but may also be quarterly, monthly, after a storm event, etc. Therefore, if multiple RSWE values are taken for the target area during the relevant timeframe, a combination of the RSWEs may be used to determine Q. For example, in a location where monthly ground SWEs are measured by a ground station, a composite RSWE for the entire snow season may be developed by linear interpolation using the combination of radar SWE and Q-hypsography.

A time-dependent SWE may be estimated based on multiple WRSWE values and multiple RSWEs for a given region obtained over time. A time-dependent SWE has many potential applications. For example, L may be modeled as a function of time based on the temporal nature of the WRSWEs. Q factors calculated over time may retain their time dependence: Q₀ⱼ=Q₀ⱼ(t) either intraseasonal or interannually. By examining Q₀(t) for a region, seasonal patterns and variations may be observed, specifically the pattern of Q₀ⱼ by elevation. For example, early season snowstorms may deposit snow at higher elevations, while late season snowstorms may extend snow deposition to lower elevations. Snow deposition at lower elevations will melt earlier in the season as temperatures warm and then melting will progress upward to higher elevations. Studying Q₀(t) therefore can provide water managers a more complete understanding of the deposition patterns of SWE for each elevation band in a target area, and in turn a better appreciation for when snowmelt will release into the watershed. Examining the evolution of the Q₀(t) may also inform climate shifts and weather pattern changes.

Q factor analysis may also be used to improve SWE estimates through better ground station siting and correction of existing ground stations. With knowledge of Q distribution by elevation band, new ground stations can be located so that RSWE measurements taken at those locations reflect the average Q-value for the surrounding area. For existing stations that are known to under- or overestimate SWE based on RSWE measurements taken at those locations, an adjustment factor can be applied based on Q-hypsography and terrain maps of the surrounding area. For even more precise SWE estimates, ground measurement stations should be sited in an area where Q consistently falls between Q=1.95 and Q=2.25, or equivalently in an area bounded by contour lines defined by Q=2±ε, where ε is 0.05.

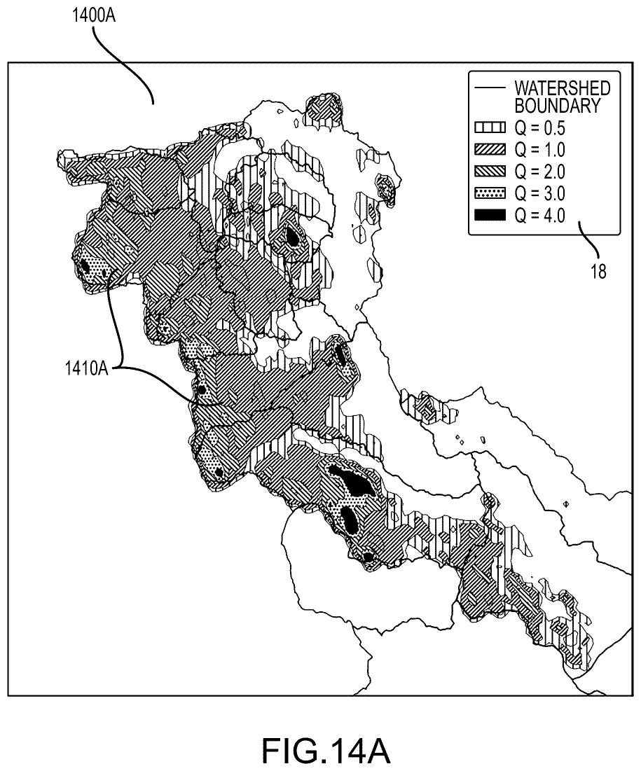

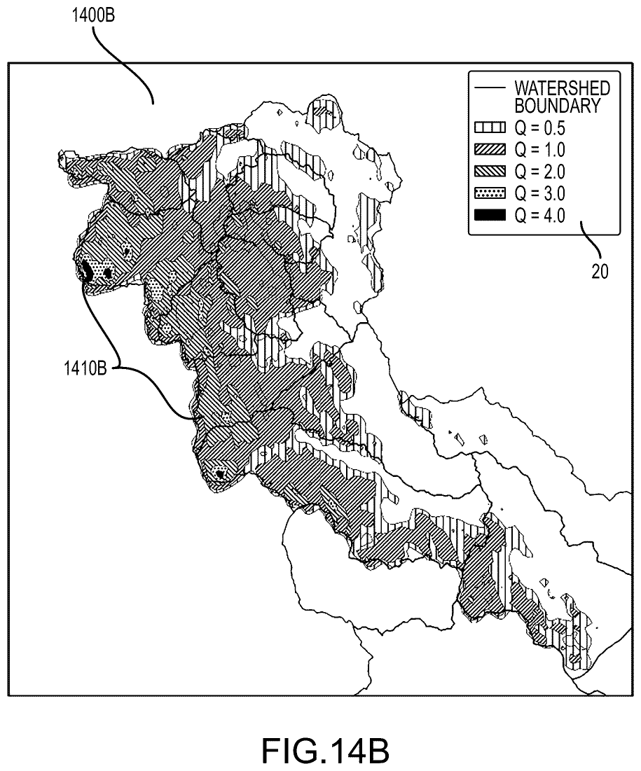

Spatially distributed Q values are mapped over a target area and compared with ground elevations, deriving a Q-hypsograph relationship, which is then used to estimate SWE. With reference to FIG. 14A, a map 1400A is depicted showing spatially distributed Q values mapped as contours 1410A in a Year 1 over a region of interest covered by weather radar. A key 18 shows contours for Q=0.5, 1.0, 2.0, 3.0, and 4.0. With reference to FIG. 14B, a similar map 1410B to that shown in FIG. 14A shows the same contour 1410B information but for Year 2. A key 20 shows contours for Q=0.5, 1.0, 2.0, 3.0, and 4.0. The similarity in Q-contour pattern is striking and further illustrates the durable nature of Q over time.

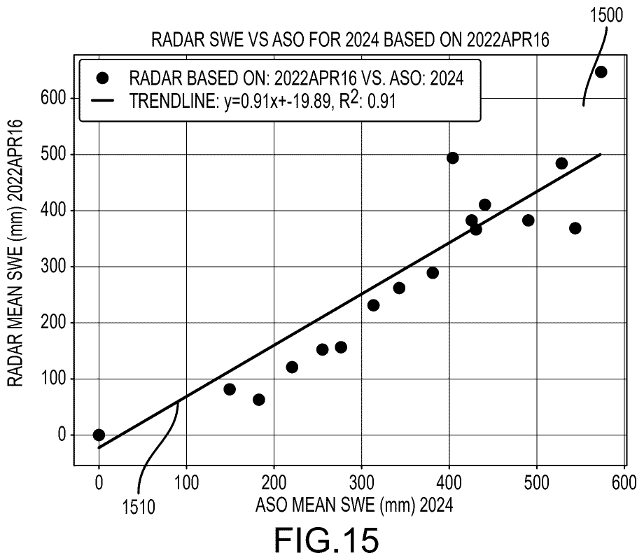

Another application of the disclosed invention is the forward estimation of SWE using radar estimates of WRSWE together with previous year Q-hypsograph and micro parameters. As taught herein, forward estimation does not require current LiDAR RSWE measurements to be made each season or during the season to produce accurate SWE ground distributions. FIG. 15 depicts a chart 1500 showing the accuracy of CSWE projections for 2024 using current WRSWE and Q-hypsography and microphysical parameters determined for 2022. The y-axis shows radar mean SWE or CSWE in millimeters, while the x-axis shows ASO mean SWE or RSWE in millimeters. The data points plotted represent zonal averages of CSWE versus RSWE computed as averages over watershed areas comprising a river basin. The trendline between CSWE and RSWE 1510 follows approximately a 1:1 relationship within 10% (slope=0.91) and with a high correlation coefficient, R²=0.91. This is remarkably close to the estimation accuracy achieved using CSWE and RSWE from the same year, which had a slope of 0.89.

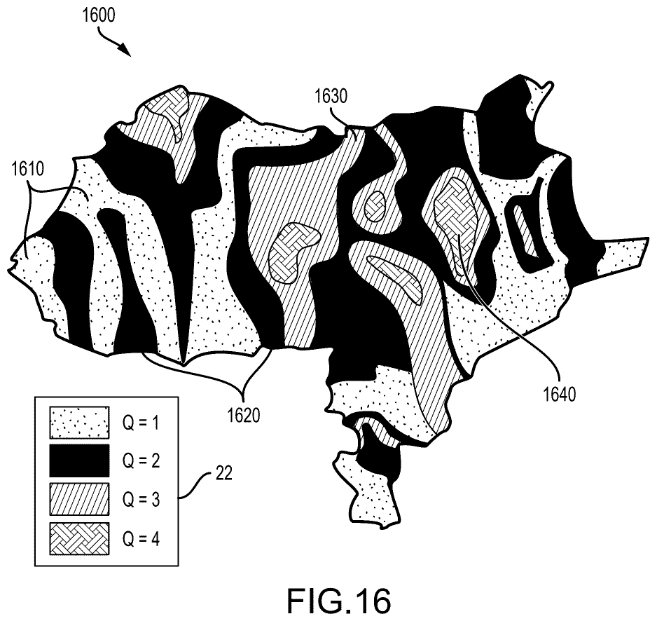

With reference to FIG. 16 is depicted an exemplary contour map 1600 wherein the identified contours have Q values of Q=1 1610, Q=2 1620, Q=3 1630, and Q=4 1640. A key 22 shows shading assigned to each Q value. The contour map shows the orderly progression of Q-hypsography within the depicted region, which represents a subwatershed target area. Such maps may be used to identify sites for new snow monitoring stations that will provide consistent and representative SWE data over multiple years. Contour areas 1620 where the subwatershed average Q value is Q=2.0±ε represent potential areas for siting a ground station. Due to annual variations, siting the ground station where the Q contours for multiple years overlap will account for natural variability in snow accumulation, and therefore increase the probability that SWE reading taken at that station will be representative of the area average. The probability of correctly siting a ground station with the correct Q value improves as more snowfall seasons are considered. Q contour maps may also be used to develop a calibration or bias factor that could correct SWE measurements from an existing ground station to make the measurements more representative of ground SWE deposition over the entire target area or subwatershed.

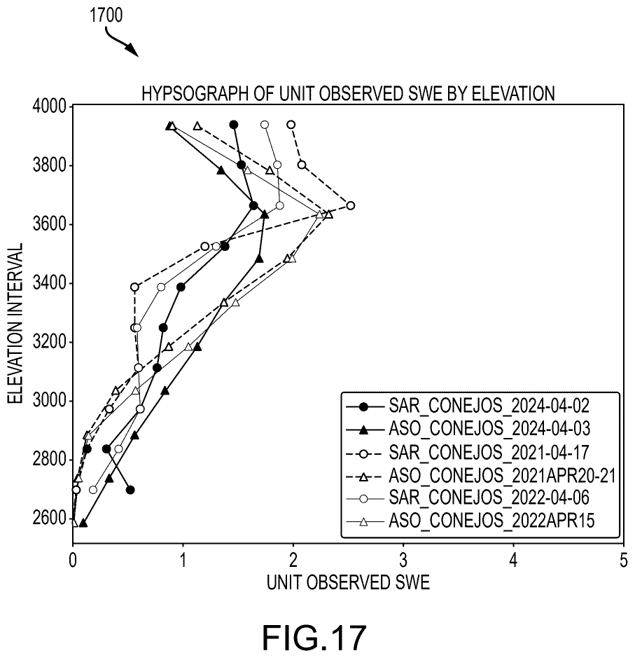

With reference to FIG. 17 is a graph 1700 depicting hypsographic analysis of SAR readings compared with LiDAR readings taken by the Airborne Snow Observatory (ASO) for the same year and approximately the same date. The y-axis shows elevation intervals ranging from 2600 to 4000 meters above sea level. The x-axis shows dimensionless Unit Observed SWE. The coherence in measurements is significant, with both ASO and SAR showing peak accumulation at 3650 m and declining to near zero below 2600 m. It is noteworthy that in some years such as 2024 that have lower peak, but elevated SWE at lower elevations indicative of an early ASO measurement before melting has occurred in early April. Conversely, SAR and ASO show higher peak SWE in 2021 when both were measured in late April. Elevations below 3100 have less SWE, indicating that snow melt has occurred. As seen in FIGS. 12 and 17, because the hypsograph is normalized, the peak increases to compensate for less SWE at lower elevations.

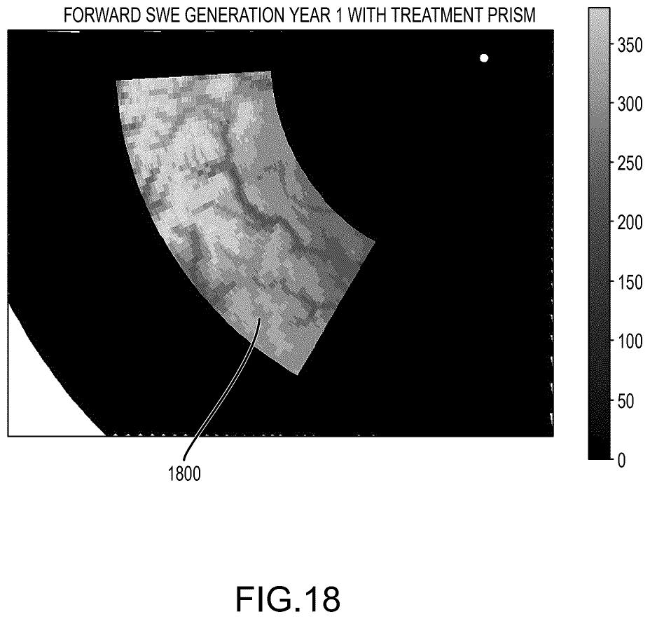

With reference to FIG. 18 is shown a map 1800 of SWE plotted over a region using PRISM data as RSWE. Maps assembled using PRISM data are more useful for SWE analysis than a map constructed using LiDAR (ASO) data because the coverage area for PRISM analysis extends regionally beyond the LiDAR collection area. The extension of the disclosed method by use of PRISM and SAR data allows regional SWE estimation without reliance on LiDAR (ASO) data, or the limited coverage and expense of LiDAR data.

### SUMMARY

A method for estimating snow water equivalent (SWE), the method comprising:
receiving radar data from a weather radar, wherein the radar data includes samples of precipitation over a region of interest (ROI);
receiving parameters relevant to interactions between precipitation and radar signals;
calculating, using the radar data and the parameters, a weather radar SWE (WRSWE);
receiving a reference SWE (RSWE) for a location in the ROI;
determining a loss function (L), wherein L equals the WRSWE minus the RSWE;
minimizing L as a function of the parameters and Q, wherein Q is a correction factor for WRSWE;
determining, using the minimized L, an optimized Q (Q₀) and optimized parameters for the location; and
calculating, using the optimized parameters, an optimized WRSWE for the location; and
calculating a corrected WRSWE (CSWE) for the location by multiplying the optimized WRSWE by Q₀.

The method for estimating SWE of Para [00118], further comprising:
mapping Q₀ to a map of the ROI by using Q₀ at the location to distribute interpolated Q₀ values within the ROI; and
mapping the CSWE to the map by multiplying the optimized WRSWE by Q₀ at the location and by the interpolated Q₀ values elsewhere within the ROI.

The method for estimating SWE of Para [00118], wherein the radar data includes a wavelength of the weather radar, a specific differential phase, a differential phrase, a vertical reflectivity, and a horizontal reflectivity.

The method for estimating SWE of Para [00118], wherein the parameters include α₁ and B₁ from the relation ρₛ(D)=α₁D^{B}^{₁}; δ₁ and d₁ from the relation

$${V}_{t} = {d}_{1} \cdot {( \frac{{p}_{0}}{{p}_{a}} )}^{0.5} \cdot {D}^{{δ}_{1}} ;$$

and σ, wherein σ is related to a canting angle distribution for precipitation.

The method for estimating SWE of Para [00118], wherein the RSWE is one of: an SWE derived from a LiDAR measurement; an SWE measured at a ground station; a SWE derived from maps and models of snow deposition; or an SWE derived from a prior estimation of SWE.

The method for estimating SWE of Para [00118], wherein the radar data includes a plurality of data sets captured at sequential capture times, each capture time separated by a time step, the method further comprising:
performing, iteratively, the calculating a WRSWE step through the calculating a CSWE step for each data set of the plurality of data sets; and
calculating a cumulative CSWE by adding each CSWE calculated for each data set.

The method for estimating SWE of Para [00118], the minimizing step further comprising:
receiving a data set captured at a point in time;
receiving a RSWE for the point in time;
setting an initial value and a permissible range for each of the parameters;
calculating an initial WRSWE using the initial value for each of the parameters.
setting a varied value for each of the parameters, wherein the varied value is within the permissible range;
calculating an adjusted WRSWE using the varied value for each of the parameters;
determining an L for the adjusted WRSWE;
comparing the L to an acceptable error range;
repeating the calculating an adjusted WRSWE step through the comparing step if the L is not within the acceptable range;
setting the adjusted WRSWE as the optimized WRSWE and L as a minimized L; and
determining, using the minimized L, an optimized Q (Q₀) and optimized parameters.

The method for estimating SWE of Para [00124], wherein the method is a computer-implemented method, and wherein the repeating step includes using a machine learning model to minimize L based on one of the following: historical data or technical data.

The method for estimating SWE of Para [00124], further comprising:
receiving a plurality of data sets captured at sequential time steps over a period of interest;
receiving a RSWE for each time step;
setting an initial value and a permissible range for each of the parameters;
calculating an initial WRSWE for a first time step using the initial value for each of the parameters; setting a varied value for each of the parameters, wherein the varied value is within the permissible range;
calculating an adjusted WRSWE using the varied value for each of the parameters;
determining an L for the adjusted WRSWE;
comparing the L to an acceptable error range;
repeating the calculating an adjusted WRSWE step through the comparing step if the L is not within the acceptable range;
setting the adjusted WRSWE as an optimized WRSWE for the first time step and L as a minimized L;
determining, using the minimized L, an optimized Q (Q₀) and optimized parameters; and determining an optimized WRSWE for each time step.

The method for estimating SWE of Para [00126], wherein the period of interest is one of a single weather event, a week, a month, a snowfall season, or a year.

The method for estimating SWE of Para [00118], wherein the steps after the calculating a WRSWE step comprise:
determining a constant Q (Q_{c}), wherein Q_{c} is an averaged Q value for the ROI;
determining optimized parameters by averaging the parameters for a series of WRSWE values; and
calculating, using the optimized parameters, an optimized WRSWE for the ROI; and
calculating a corrected WRSWE (CSWE) for the ROI by multiplying the optimized WRSWE by Qc.

A system for estimating snow water equivalent (SWE), the system comprising:
radar data, including samples of precipitation over a region of interest (ROI);
parameters relevant to interactions between precipitation and radar signals;
a reference SWE (RSWE) for a location in the ROI;
a graphical user interface;
memory configured to store instructions that are executable on a computer;
a computer processor configured to access memory and execute the instructions to:
   calculate, using the radar data and the parameters, a weather radar SWE (WRSWE);
   determine a loss function (L), wherein L equals the WRSWE minus the RSWE;
   minimize L as a function of the parameters and Q, wherein Q is a correction factor for WRSWE;
   determine, using the minimized L, an optimized Q (Q₀) and optimized parameters for the location; and
   calculate, using the optimized parameters, an optimized WRSWE for the location; and
   calculate a corrected WRSWE (CSWE) for the location by multiplying the optimized WRSWE by Q₀.

The system for estimating SWE of Para [00129], further comprising:
a map of the ROI;
wherein the computer processor is further configured to:
   map Q₀ to the map by using Q₀ at the location to distribute interpolated Q₀ values within the ROI; and
   map the CSWE to the map of the ROI by multiplying the optimized WRSWE by Q₀ at the location, and by the interpolated Q₀ values within the ROI.

The system for estimating SWE of Para [00129], wherein the radar data includes a plurality of data sets captured at sequential capture times, each capture time separated by a time step; and
wherein the computer processor is further configured to:
iteratively perform the calculate a WRSWE step through the calculate a CSWE step for each data set of the plurality of data sets; and
calculate a cumulative CSWE by adding each CSWE calculated for each data set.

The system for estimating SWE of Para [00129], wherein the radar data includes a plurality of data sets captured at sequential time steps over a period of interest;
further comprising an RSWE corresponding to each time step; and
wherein the computer processor is further configured to:
   set an initial value and a permissible range for each of the parameters;
   calculate an initial WRSWE for a first time step using the initial value for each of the parameters.
   set a varied value for each of the parameters, wherein the varied value is within the permissible range;
   calculate an adjusted WRSWE using the varied value for each of the parameters;
   determine an L for the adjusted WRSWE;
   compare the L to an acceptable error range;
   repeat the calculate an adjusted WRSWE step through the compare step if the L is not within the acceptable range;
   sett the adjusted WRSWE as an optimized WRSWE for the first time step and L as a minimized L;
   determine, using the minimized L, an optimized Q (Q₀) and optimized parameters; and
   determine an optimized WRSWE for each time step.

The system for estimating SWE of Para [00132], wherein the repeat step includes using a machine learning model to minimize L based on one of historical data or technical data.

A method for developing a Q hypsograph, the method comprising:
overlaying a grid on a map of a region of interest (ROI), the map including a plurality of elevation bands, each elevation band representing a range of elevations above sea level;
determining, using radar data, a weather radar snow water equivalent (WRSWE) value for a location in the ROI, wherein the location falls within an associated elevation band of the plurality of elevation bands;
receiving a reference snow water equivalent (RSWE) value for the location;
calculating a Q₀ value for the location; and
extrapolating the Q₀ value for all locations within the associated elevation band.

The method for developing a Q hypsograph of Para [00134], further comprising:
determining, using radar data, a WRSWE value for a plurality of locations in the ROI, wherein each of the plurality of locations is within an associated elevation band;
receiving a RSWE value for each of the plurality of locations;
calculating a Q₀ value for each of the plurality of locations; and
assigning an elevation band Q₀ value to the associated elevation band containing each of the plurality of locations.

The method for developing a Q hypsograph of Para [00134], wherein the ROI is a watershed, a sub-watershed, or a plurality of watersheds.

The method for developing a Q hypsograph of Para [00134], further comprising:
extrapolating the RSWE value for all locations within the associated elevation band.

The method for developing a Q hypsograph of Para [00134], further comprising:
calculating a corrected WRSWE (CSWE) value for the location; and
extrapolating the CSWE value for all locations within the associated elevation band.

As will be understood by those familiar with the art, the disclosed invention may be embodied in other specific forms without departing from the spirit or essential characteristics thereof. Likewise, the particular naming and division of the modules, managers, functions, systems, layers, features, attributes, methodologies, and other aspects are not mandatory or significant, and the mechanisms that implement the invention or its features may have different names, divisions, and/or formats. Accordingly, the disclosure of the present invention is intended to be illustrative, but not limiting, of the scope of the invention.

This has been a description of the disclosed invention along with a preferred method of practicing the invention.

1. A method for estimating snow water equivalent (SWE), the method comprising:
receiving radar data from a weather radar, wherein the radar data includes one or more samples of precipitation over a region of interest (ROI);
receiving parameters relevant to interactions between precipitation and radar signals;
calculating, using the radar data and the parameters, a weather radar SWE (WRSWE);
receiving a reference SWE (RSWE) for a location in the ROI;
determining a loss function (L), wherein L equals the WRSWE minus the RSWE;
minimizing L as a function of the parameters and Q, wherein Q is a correction factor for WRSWE;
determining, using the minimized L, an optimized Q (Q₀) and optimized parameters for the location;
calculating, using the optimized parameters, an optimized WRSWE for the location; and
calculating a corrected WRSWE (CSWE) for the location by multiplying the optimized WRSWE by Q₀.

2. The method for estimating SWE of claim 1, further comprising:
mapping Q₀ to a map of the ROI by using Q₀ at the location to distribute one or more interpolated Q₀ values to one or more additional locations within the ROI; and
mapping the CSWE to the map by multiplying the optimized WRSWE by Q₀ at the location and by multiplying the optimized WRSWE by the one or more interpolated Q₀ values at the one or more additional locations.

3. The method for estimating SWE of claim 1, wherein the radar data includes a wavelength of the weather radar, a specific differential phase, a differential phrase, a vertical reflectivity, and a horizontal reflectivity.

4. The method for estimating SWE of claim 1, wherein the parameters include α₁ and B₁ from the relation ρₛ(D)=α₁D^{B}^{₁}; and δ₁ and d₁ from the relation
$${V}_{t} = {d}_{1} \cdot {( \frac{{p}_{0}}{{p}_{a}} )}^{0.5} \cdot {D}^{{δ}_{1}} ;$$
and σ, wherein σ is related to a canting angle distribution for precipitation.

5. The method for estimating SWE of claim 1, wherein the RSWE is one of: an SWE derived from a LiDAR measurement; an SWE measured at a ground station; an SWE derived from maps and models of snow deposition; or an SWE derived from a prior estimation of SWE.

6. The method for estimating SWE of claim 1, wherein the radar data includes a plurality of data sets captured at sequential capture times, each capture time separated by a time step, the method further comprising:
performing, iteratively, the calculating a WRSWE step through the calculating a CSWE step for each data set of the plurality of data sets; and
calculating a cumulative CSWE by adding each CSWE calculated for each data set.

7. The method for estimating SWE of claim 1, the minimizing step further comprising:
receiving a data set captured at a point in time;
receiving a RSWE for the point in time;
setting an initial value and a permissible range for each of the parameters;
calculating an initial WRSWE using the initial value for each of the parameters;
setting a varied value for each of the parameters, wherein the varied value is within the permissible range;
calculating an adjusted WRSWE using the varied value for each of the parameters;
determining an L for the adjusted WRSWE;
comparing the L to an acceptable error range;
repeating the calculating an adjusted WRSWE step through the comparing step if the L is not within the acceptable range;
setting the adjusted WRSWE as the optimized WRSWE and L as a minimized L; and
determining, using the minimized L, an optimized Q (Q₀) and optimized parameters.

8. The method for estimating SWE of claim 7, wherein the method is a computer-implemented method, and wherein the repeating step includes using a machine learning model to minimize L based on one of the following: historical data or technical data.

9. The method for estimating SWE of claim 7, further comprising:
receiving a plurality of data sets captured at sequential time steps over a period of interest;
receiving a RSWE for each time step;
setting an initial value and a permissible range for each of the parameters;
calculating an initial WRSWE for a first time step using the initial value for each of the parameters;
setting a varied value for each of the parameters, wherein the varied value is within the permissible range;
calculating an adjusted WRSWE using the varied value for each of the parameters;
determining an L for the adjusted WRSWE;
comparing the L to an acceptable error range;
repeating the calculating an adjusted WRSWE step through the comparing step if the L is not within the acceptable range;
setting the adjusted WRSWE as an optimized WRSWE for the first time step and L as a minimized L;
determining, using the minimized L, an optimized Q (Q₀) and optimized parameters; and
determining an optimized WRSWE for each time step.

10. The method for estimating SWE of claim 9, wherein the period of interest is one of a single weather event, a week, a month, a snowfall season, or a year.

11. A method for estimating snow water equivalent (SWE), the method comprising:
receiving radar data from a weather radar, wherein the radar data includes one or more samples of precipitation over a region of interest (ROI):
receiving parameters relevant to interactions between precipitation and radar signals:
calculating, using the radar data and the parameters, a weather radar SWE (WRSWE):
determining a constant Q (Q_{c}), wherein Q_{c} is an averaged Q value for the ROI;
determining optimized parameters by averaging the parameters for a series of WRSWE values;
calculating, using the optimized parameters, an optimized WRSWE for the ROI; and
calculating a corrected WRSWE (CSWE) for the ROI by multiplying the optimized WRSWE by Q_{c}.

12. A system for estimating snow water equivalent (SWE), the system comprising:
radar data, including one or more samples of precipitation over a region of interest (ROI);
parameters relevant to interactions between precipitation and radar signals;
a reference SWE (RSWE) for a location in the ROI;
a graphical user interface;
memory configured to store instructions that are executable on a computer;
a computer processor configured to access memory and execute the instructions to:
calculate, using the radar data and the parameters, a weather radar SWE (WRSWE);
determine a loss function (L), wherein L equals the WRSWE minus the RSWE;
minimize L as a function of the parameters and Q, wherein Q is a correction factor for WRSWE;
determine, using the minimized L, an optimized Q (Q₀) and optimized parameters for the location; and
calculate, using the optimized parameters, an optimized WRSWE for the location; and
calculate a corrected WRSWE (CSWE) for the location by multiplying the optimized WRSWE by Q₀.

13. The system for estimating SWE of claim 12, further comprising: a map of the ROI;
wherein the computer processor is further configured to:
map Q₀ to the map by using Q₀ at the location to distribute one or more interpolated Q₀ values to one or more additional locations within the ROI; and
map the CSWE to the map of the ROI by multiplying the optimized WRSWE by Q₀ at the location, and by the one or more interpolated Q₀ values at the one or more additional locations.

14. The system for estimating SWE of claim 12, wherein the radar data includes a plurality of data sets captured at sequential capture times, each capture time separated by a time step; and
wherein the computer processor is further configured to:
iteratively perform the calculate a WRSWE step through the calculate a CSWE step for each data set of the plurality of data sets; and
calculate a cumulative CSWE by adding each CSWE calculated for each data set.

15. The system for estimating SWE of claim 12, wherein the radar data includes a plurality of data sets captured at sequential time steps over a period of interest;
further comprising an RSWE corresponding to each time step; and
wherein the computer processor is further configured to:
set an initial value and a permissible range for each of the parameters;
calculate an initial WRSWE for a first time step using the initial value for each of the parameters;
set a varied value for each of the parameters, wherein the varied value is within the permissible range;
calculate an adjusted WRSWE using the varied value for each of the parameters;
determine an L for the adjusted WRSWE;
compare the L to an acceptable error range;
repeat the calculate an adjusted WRSWE step through the compare step if the L is not within the acceptable range;
set the adjusted WRSWE as an optimized WRSWE for the first time step and L as a minimized L;
determine, using the minimized L, an optimized Q (Q₀) and optimized parameters; and
determine an optimized WRSWE for each time step.

16. The system for estimating SWE of claim 15, wherein the repeat step includes using a machine learning model to minimize L based on one of historical data or technical data.

17. A method for developing a Q-hypsograph, the method comprising:
overlaying a grid on a map of a region of interest (ROI), the map including a plurality of elevation bands, each elevation band representing a range of elevations above sea level;
determining, using radar data, a weather radar snow water equivalent (WRSWE) value for a location in the ROI, wherein the location falls within an associated elevation band of the plurality of elevation bands;
receiving a reference snow water equivalent (RSWE) value for the location;
calculating a Q₀ value for the location; and
extrapolating the Q₀ value for all locations within the associated elevation band.

18. The method for developing a Q-hypsograph of claim 17, further comprising:
determining, using radar data, a WRSWE value for a plurality of locations in the ROI, wherein each of the plurality of locations is within an associated elevation band;
receiving a RSWE value for each of the plurality of locations;
calculating a Q₀ value for each of the plurality of locations; and
assigning an elevation band Q₀ value to the associated elevation band containing each of the plurality of locations.

19. The method for developing a Q-hypsograph of claim 17, wherein the ROI is a watershed, a sub-watershed, or a plurality of watersheds.

20. The method for developing a Q-hypsograph of claim 17, further comprising:
extrapolating the RSWE value for all locations within the associated elevation band.

21. The method for developing a Q-hypsograph of claim 17, further comprising:
calculating a corrected WRSWE (CSWE) value for the location; and
extrapolating the CSWE value for all locations within the associated elevation band.
